(19) United States
(12) Patent Application Publication
(10) Pub. No.: US 2026/0046124 A1
(43) Pub. Date: Feb. 12, 2026

(54) RESOURCE CLASSIFICATION LAYER FOR CONSTANT REQUEST VERIFICATION IN ZERO TRUST SYSTEMS

(71) Applicant: T-Mobile USA, Inc., Bellevue, WA (US)

(72) Inventors: Sridhar Bandaru, Frisco, TX (US); Jason M. Farmer, Overland Park, KS (US)

(21) Appl. No.: 18/799,939

(22) Filed: Aug. 9, 2024

(51) Int. Cl. H04L 9/08

(52) U.S. Cl. CPC H04L 9/088

(57) ABSTRACT

A method is disclosed for managing access in a telecommunications network by utilizing a resource classification layer. The method involves receiving a request at a resource classification layer from a sender to obtain an access token for a receiver service. The sender is associated with a user role that has specific permissions and access rights corresponding to a data sensitivity threshold. The request includes a data payload. A classification value for the data payload is assigned using one or more resource classification models, which are trained on a log of past data payloads. A data sensitivity score is generated by comparing the classification value to a scale of classification values. The method then indicates whether the access token can be granted to the sender by comparing the data sensitivity score against the data sensitivity threshold to verify authorization.

### BACKGROUND

Telecommunications involves the transmission of information over distances using electronic systems, such as telephones, radios, televisions, and the internet. It enables voice, data, and video communication, connecting people and businesses worldwide. One of the latest advancements in telecommunications is 5G, the fifth generation of mobile network technology. As 5G networks offer significantly higher speeds, lower latency, and greater connectivity compared to previous generations, they enable a wider range of services and applications, such as the Internet of Things (IoT), smart cities, and advanced mobile broadband.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flow chart diagram that illustrates components of an example method to verify requests.

FIG. 4A is a flow chart diagram that illustrates operations of an example resource classification layer in accordance with one or more embodiments of the present technology.

FIG. 4B is another flow chart diagram that illustrates operations of an example resource classification layer in accordance with one or more embodiments of the present technology.

FIG. 4C is another flow chart diagram that illustrates operations of an example resource classification layer in accordance with one or more embodiments of the present technology.

FIG. 5 is a block diagram that illustrates an example of an artificial intelligence system in which at least some operations described herein can be implemented.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The expansion of 5G wireless communication technology in services results in the generation and collection of detailed and extensive Customer Proprietary Network Information (CPNI), including usage patterns, location data, and service preferences. CPNI in the telecommunications industry refers to the data collected by telecommunications companies about their subscribers, such as service details, usage information, billing information, and/or technical information. The protection of CPNI is important for ensuring customer privacy, building trust, maintaining regulatory compliance, and enhancing overall cybersecurity efforts. Safeguarding CPNI helps telecommunications companies avoid legal penalties and foster a secure environment for customer data.

Zero Trust is an IT security model that requires strict identity verification for every person and device trying to access resources on a network. This means that no one is trusted by default, either inside or outside the network. While this added layer of security has been shown to prevent data breaches, it also requires verification for every resource request made on the network. Given this high bar for verification, implementing a Zero Trust security model can be difficult. Network data that can be used to identify a subscriber of a telecommunications network ranges from public data (e.g., press releases, or marketing materials) to CPNI (e.g., call detail records). Each request for data can be handled differently by the system, according to the data's level of sensitivity. Current approaches of implementing Zero Trust include manually auditing the logs for transaction payloads to identify if there is any potentially sensitive data. For telecommunication networks that comprise numerous applications running continually and concurrently while sharing and generating data of varying levels of sensitivity, manual solutions are not practicable.

This patent document discloses techniques that can be implemented in various embodiments to provide Zero Trust level protection of a data payload to enable enforcement of a Zero Trust policy in communication systems. In some embodiments, one or more resource classification layers, implemented using machine-learning (ML) modules or rule engine(s), can be used to audit data types and ensure a commensurate user role is granted to requests for such data types. The disclosed technology can solve the problem of enforcing a security policy for individual features of sensitive data types that have become disassociated from the protected data type. For example, the Mobile Station International Subscriber Directory Number (MSISDN) is not related to CPNI on its own, but it can still allow those with access to trace sensitive data back to a subscriber of a telecommunications network. In some embodiments, a requested feature of a sensitive data type can be provided as input to a machine learning model, which can output a data score indicating a sensitivity of the requested feature. If the data score exceeds a sensitivity threshold, the disclosed technology can block the requested feature from being returned, unless the user role of the user who requested the feature includes a privilege to access the requested feature.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

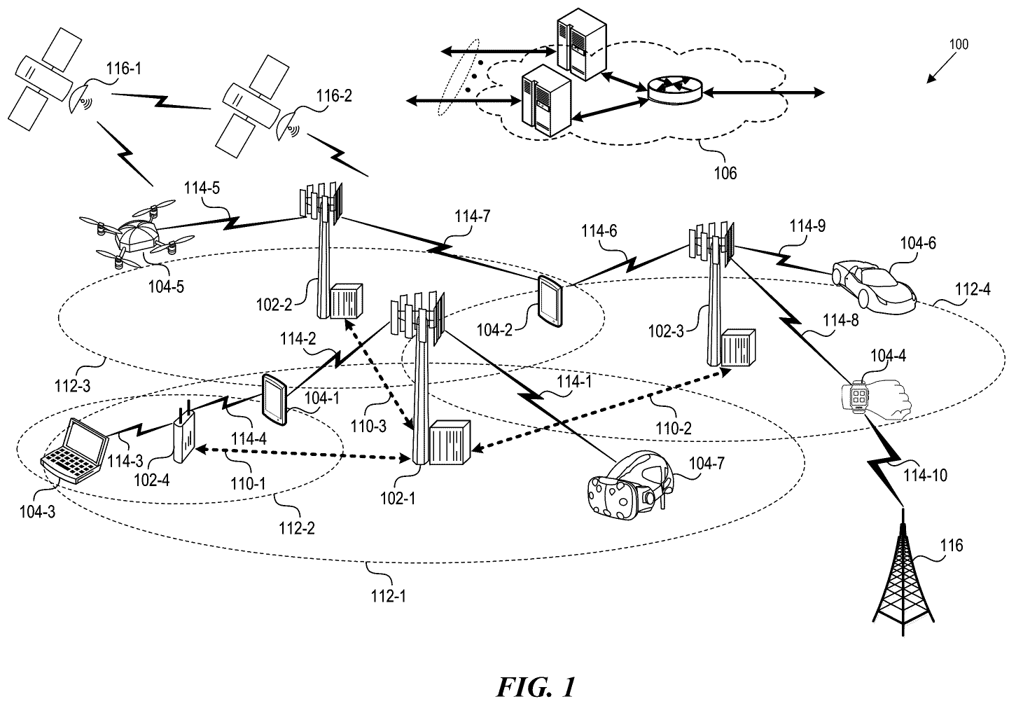

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

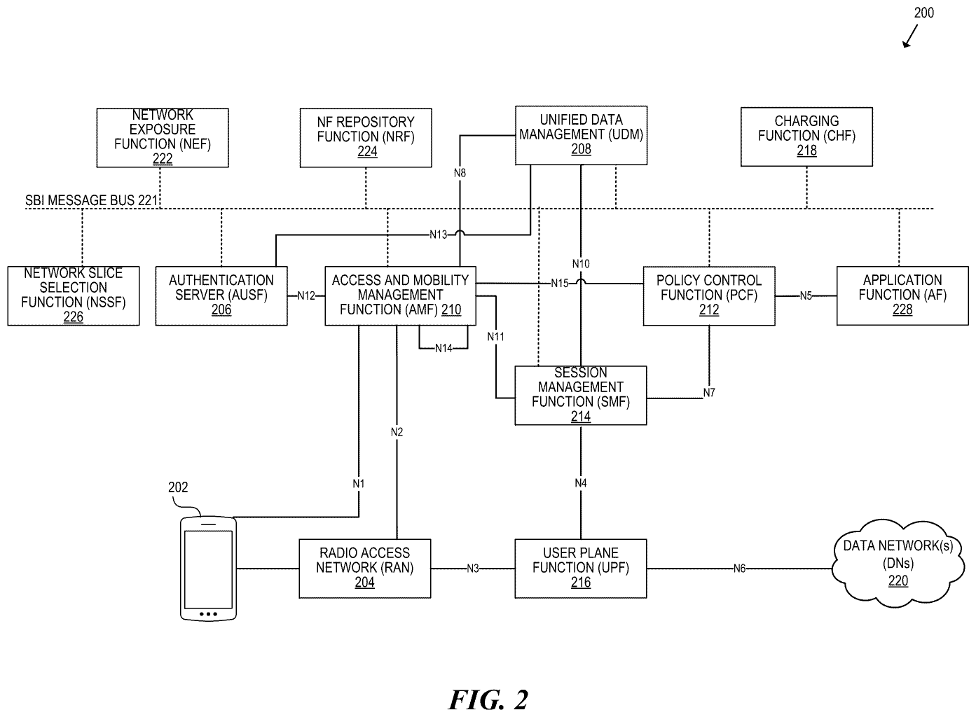

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Resource Classification Layer for Constant Request Verification in Zero Trust Systems

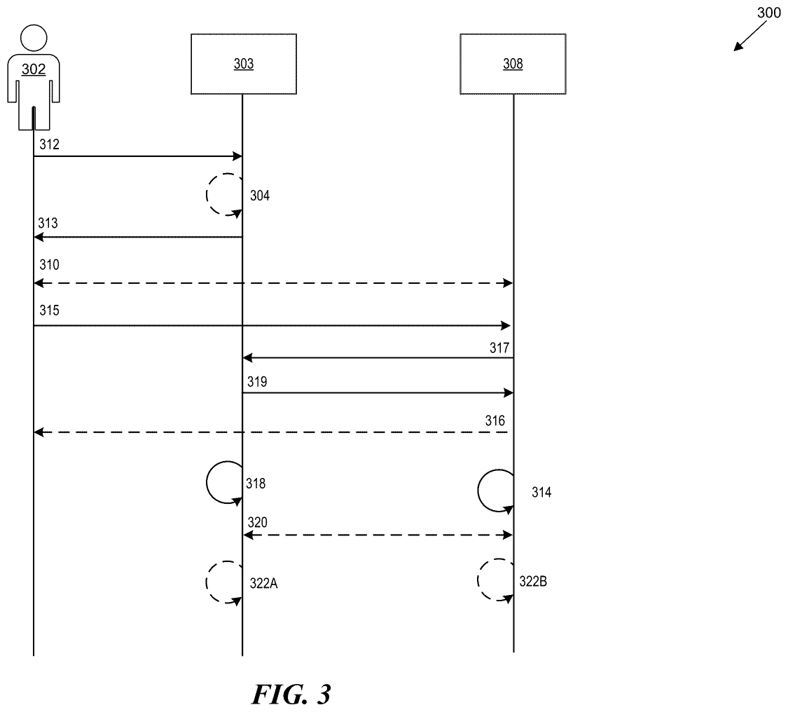

Currently, security protocols such as Oauth2 are used to perform user authorization. FIG. 3 is a flow chart diagram that illustrates an example method 300 to verify requests.

The method 300 includes sending a request 312. The request 312 can be a request to obtain an access token, sent as a stream of bytes over a connection 310 from a client 302 to an authorization server 303. The request 312 can be addressed to a destination 308, but first handled by the authorization server 303. For example, the access token can be provided by the authorization server 303, enabling the client 302 to access a resource server at the destination 308. In some implementations, sending the request 312 is accomplished by writing data to a socket at the destination 308. Additionally, sending the request 312 can include flushing the socket to ensure data comprised by the request 312 is sent immediately. The request 312 can include a method (e.g., GET, or POST), headers (e.g., Host, User-Agent, Accept), and a body.

In the method 300, the client 302 can conduct a request initialization 304. The request initialization 304 can include specifying the destination 308 (e.g., a server) for the request 312. The destination 308 can host a resource server, which can be accessible via an API or a collection of APIs. Specifying the destination 308 can include parsing an address (e.g., a URL, or an IP address). Parsing the address can include extracting components, such as the protocol (e.g., HTTP, HTTPS, GraphQL, FTP, WebSocket, REST, SOAP, RPC, MQTT, or Thrift). Other example components include a host, port, path, query parameters, and fragment. Specifying the destination 308 can include resolving the address to the destination 308 by using a lookup server (e.g., DNS).

Additionally, request initialization 304 can include authorizing the client 302 to access the resource server at the destination 308. Such an authorization process can include comparing access rights and privileges of a user role of the client 302 against a security level of the resource server. In some implementations, the request 312 includes a key to grant access to the destination 308. In an operation 313, the authorization server 303 can return the access token to the client 302 after successfully authorizing the client 302 in the request initialization 304.

The method 300 can include establishing a connection 310 (e.g., a TCP connection). The connection 310 is established between the client 302 and the destination 308. Establishing the connection can include using the resolved address A Transmission Control Protocol (TCP) connection is established between the client and the server using the resolved address, in addition to the port (e.g., port 80 for HTTP, or port 443 for HTTPS). Establishing the connection 310 can include the client 302 sending a first message to the destination 308 to synchronize (e.g., a SYN packet), the destination 308 sending a second message to acknowledge (e.g., a SYN-ACK packet), and the client finalizing with a confirmation message (e.g., an ACK packet).

Establishing the connection 310 can include additional security. Additional security can include a handshake procedure to establish a secure connection. This can involve negotiating encryption parameters, authenticating the destination 308 or the client 302 using digital certificates, or exchanging encryption keys, or some combination of the foregoing.

Over the connection 310, the client 302 can send a second request 315. The second request 315 can be a request for a resource from the resource server at the destination 308. The second request 315 can include the access token.

The method 300 includes an operation 314 in which the destination 308 processes the second request 315 Processing the request can be accomplished at the destination 308. Processing the second request 315 can include parsing the second request 315, and routing the second request 315 to an appropriate handler or endpoint. In some implementations, processing the second request includes interacting with databases or other services. The method 300 includes an operation 317, in which the destination 308 validates the access token included in the second request 315. The destination 308 can validated the access token by submitting it to the authorization server 303 in its own validation request. The method 300 includes an operation 319, in which the authorization server 303 allows or denies the client 302 access to the resource server at the destination 308.

The method 300 includes sending a response 316 (e.g., HTTP, JSON, or XML) from the destination 308 to the client 302. The response 316 can be sent back to the client 302 over the established connection 310. Sending the response 316 can include generating the response 316 at the destination 308. The response 316 can include a status line, a status code (e.g., 200 OK, 404 Not Found), and a status message. In some implementations, the status line specifies an HTTP version. In some implementations, the response 316 includes headers and a body, which can include the actual data being returned (e.g., HTML content, JSON data).

The method 300 includes processing the response 318. For example, processing the response 318 includes the client 302 receiving the response 316 from the destination 308 and parsing it. Processing the response 318 can include rendering the content (e.g., displaying a web page), executing scripts at the client 302, or handling errors (e.g., displaying an error message for a 404 status).

Optionally, the method 300 includes terminating the connection 320. In terminating the connection 320, a TCP connection can be closed. In some implementations, where the connection 310 is a persistent connection, the connection 310 may be kept open for reuse with subsequent requests. The method can include caching 322A and storage 322B. Caching 322A can include the client 302, or intermediate proxies, caching the response 316 for future use. A caching decisions can be based on caching headers (e.g., Cache-Control, or Expires). Storage 322B can include the destination 308 storing the request 312 data locally (e.g., in local storage or a database).

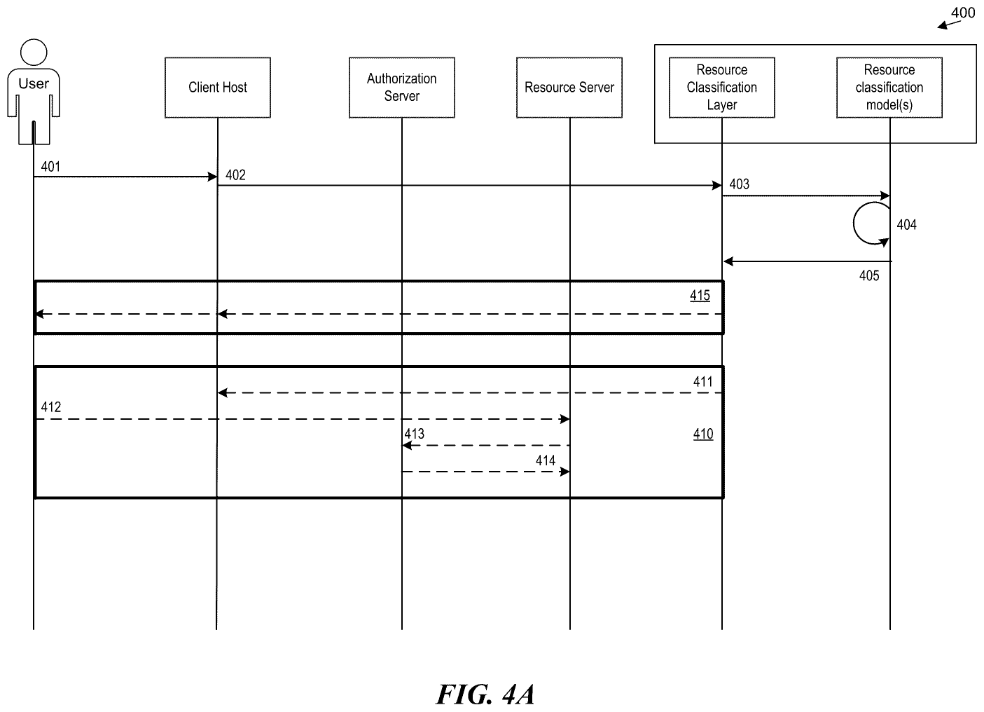

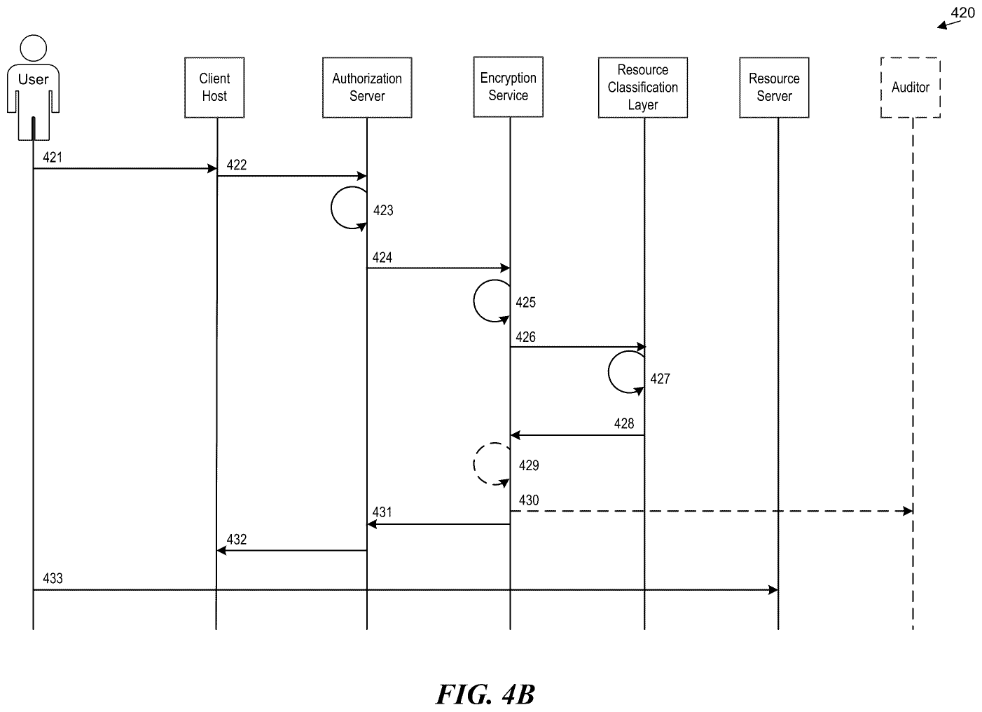

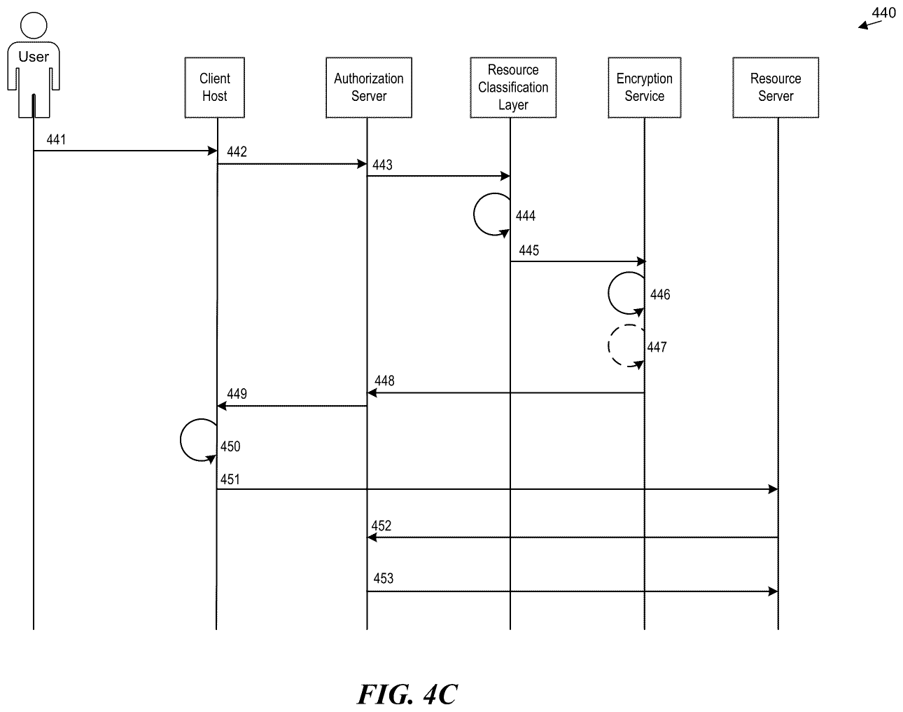

As shown in FIG. 3, no Zero Trust policy enforcement is performed in the signaling flow. Data classification (e.g., CPNI data classification), if needed, can be performed manually. To enable Zero Trust policy enforcement on data payloads in real-time or near real-time, a resource classification layer implemented using one or more ML modules or rule-based modules can be added. FIGS. 4A, 4B, and 4C are flow chart diagrams that illustrate operations of an example resource classification layer in accordance with one or more embodiments of the present technology. In some implementations, the method includes managing access to services in a telecommunications network by utilizing a resource classification layer. In some implementations, the method is executed by at least one data processor of a system, and recorded as instructions on a non-transitory, computer-readable storage medium. In some implementations, the method is stored as instructions on at least one non-transitory memory of a system and executed by at least one hardware processor of the system.

As shown in FIG. 4A, a method 400 includes an operation 401 in which a user, or a sender, sends a request to a client host to access or modify a resource at a resource server that hosts a service, or a receiver service, which the user is trying to access. In some implementations, the user has a user role with specific permissions and access rights, including a data sensitivity threshold.

The request can include a payload, or a data payload, or a potentially sensitive data payload. The payload can include a Data Model Class. The payload can be included as part of a call to the service. In some implementations, the request comprises a request for an Access Token to a service. The service can include an API, and the request can include a call to the API, and the call can include the potentially sensitive data payload.

In some implementations, as illustrated in FIG. 4A, the method 400 includes an operation 402 in which the client host sends a request to a resource classification layer for an access token. The resource classification layer can be implemented as in-memory component of the client host or hosted by an external service included within a telecommunications network. The resource classification layer can screen or alter the data payload to prevent a cybersecurity attack (e.g., an injection attack). In some implementations, the request at operation 402 also includes a request for an authorization token, and/or a request for an authentication token.

In some implementations, the resource classification layer includes one or more backend resource classification models. The method 400 includes an operation 403 in which the data payload is sent to the resource classification layer to the one or more resource classification models. In operation 404, the one or more resource classification models determine and assign a resource classification based on the data payload. In some implementations, a resource classification model assigns the resource classification by outputting a predicted resource classification, given the payload, or data payload, as input. The resource classification model can be a machine learning model, a neural network, or a deep learning model. For example, the resource classification model is trained using payloads, or past data payloads, with known resource classifications. In such training, based on the known resource classification, the resource classification model processes the data payload through multiple layers using a feed-forward operation to produce a predicted resource classification. The resource classification model then compares the predicted resource classification to the known resource classification using a loss function, and an error is propagated backwards (e.g., using a backpropagation function) through the multiple layers to update the resource classification model's parameters.

In some implementations, the data payload includes features associated with a particular resource classification. Features can include addresses, credit card information, medical records, payment history, phone numbers, email addresses, social security numbers, driver's license numbers, full names, text messages, phone call logs, emails, and other information. Resource classifications can include internal information, restricted information, protected critical infrastructure information (PCII), customer proprietary network information (CPNI), personally identifiable information (PII), sensitive personally identifiable information (SPII), and U.S. Government customer information (USGCI). Resource classifications can be organized hierarchically according to sensitivity of related data payloads, which can be included in a scale of resource classifications.

In some implementations, the resource classification is assigned using a resource mapping. The resource mapping can include a domain (e.g., a set of data payloads), a codomain (e.g., a set of known resource classifications), and a correspondence between the domain and the codomain, which provides a scheme for mapping elements from the domain to the codomain. The correspondence can be a hash function, an approximation of a function, a transformation matrix, an encoding, a projection, or a relational mapping between database tables. The domain and codomain can comprise key-value pairs in a data structure (e.g., a hash table). The resource mapping can include a data mapping comprising pairs of data payloads, or payloads, and known resource classifications. Assigning the resource classification using the resource classification model can include identifying a matching data payload, or matching payload, with a known resource classification from the data mapping and assigning the known resource classification to the potentially sensitive data payload, or to the payload, of the call.

If the potentially sensitive data payload has multiple matching data payloads in the data mapping, assigning the resource classification can include identifying multiple resource classifications from the multiple matching data payloads. In such implementations, data sensitivity scores can be generated from the multiple resource classifications by comparing the multiple resource classifications to the scale of resource classifications. These data sensitivity scores can then be compared to each other determine the resource classification with the greatest data sensitivity score. This resource classification with the greatest data sensitivity score can then be assigned to the call. The foregoing implementations can also be implemented with payloads in place of data payloads, or models in place of data payloads, and data scores in place of data sensitivity scores, or a cumulative or derivative data score in place of the data sensitivity score.

In some implementations, the resource classification model can include an in-memory machine learning model, or a library machine learning method. The model can include supervised learning models, unsupervised learning models, reinforcement learning models, or ensemble methods. Supervised learning models can include regression (e.g., linear, or logistic), decision trees, random forests, support vector machines (SVMs), k-nearest neighbors (k-NN), or Bayesian models (e.g., Naïve Bayes classifiers), or a combination of the foregoing models. Unsupervised learning models can include clustering (e.g., density-based spatial clustering of applications with noise (DBSCAN), k-means clustering, hierarchical clustering (e.g., bottom-up, or top-down), or isolation forest), statistical methods (e.g., gaussian mixture models (GMM), kernel density estimation (KDE), or z-score, dimensionality reduction (e.g., principal component analysis (PCA), or autoencoders), probabilistic methods (e.g., hidden markov models (HMM), or Bayesian networks), or methods combining more than one of the foregoing models. Reinforcement learning models can include Q-Learning, deep Q-Networks (DQN), or policy gradient methods. Ensemble methods can include bootstrap aggregating (e.g., training different models of the foregoing on different subsets of the training data), boosting (e.g., sequentially training some of the foregoing models to correct errors of some of the other foregoing models), or stacking (e.g., training some of the foregoing models to make final predictions based on the outputs of some of the other foregoing models).

In some embodiments, the operation 404 includes generating a data sensitivity score. The data sensitivity score is also referred to as a data score. The data score can make other clients and services cautious about data logging and encrypting the data payload in their storage. The data sensitivity score can be generated by comparing the resource classification to a predefined scale of resource classifications, or by comparing the resource classification to a scale. The predefined scale of resource classifications can include categories, such as internal information, restricted information, protected critical infrastructure information (PCII), customer proprietary network information (CPNI), personally identifiable information (PII), sensitive personally identifiable information (SPII), and U.S. Government customer information (USGCI). Each category can be associated with a range of values on the scale, wherein the categories are arranged hierarchically, such that the resource classification with the least sensitive data comprises the range of lowest values, and is therefore positioned at the bottom of the scale (e.g., internal information). Comparatively, the resource classification with the most sensitive data can comprise the range of highest values, and be positioned at the top of the scale (e.g., USGCI). In some implementations, generating the data sensitivity score includes inferring a corresponding range of values for the assigned resource classification, based on a position of a matching category on the scale, and selecting the data sensitivity score from the range of values.

The method 400 includes an operation 405 in which the resource classification model transmits the data score to the resource classification layer. The resource classification layer can weigh the data sensitivity score against the data sensitivity threshold of the client's user role to verify authorization. In some implementations, the data score is transmitted to a validation layer where the score is weighed against the threshold and their request is authorized. The validation layer can be different from the resource classification layer.

The operation 406 can occur at the resource classification layer, as illustrated in FIG. 4A. The data sensitivity threshold can be a data threshold, and the data sensitivity score can be a data score. The data sensitivity threshold can indicate the permissions and access rights of the client's user role. For example, a client associated with an administrator user role can have a higher data sensitivity threshold, enabling them greater access to resource classifications with correspondingly higher data sensitivity scores. The authorization can be a binary value (e.g., 1 or 0, true or false), or a continuous value (e.g., a probability). In some implementations, the authorization provides universal access to the entire resource classification and its associated payloads, or a universal restriction, denying access to the entire resource classification and its associated data payloads. Alternatively, the authorization can provide access to certain values of certain data payloads of a resource classification, while denying access to other values of the same data payloads within the same resource classification.

If the data sensitivity score falls below the data sensitivity threshold, the authorization can include the Access Token in a group of operations 410. The group of operations 410 can include an operation 411 in which an access token for a resource at the server is returned to the user via the client host. The group of operations 410 can include an operation 412 in which a request for the resource is sent from the user to the resource server, along with the access token. Following the operation 412, the request for the resource can be sent from the resource server to the authorization server in operation 413, in which the authorization server authorizes the user and/or authenticates the access token. The group of operations 410 can include an operation 414, in which the authorization server either grants the user access or denies the access.

On the other hand, if the data sensitivity score equals or exceeds the data sensitivity threshold, then the authorization can include a Classified Data Error in a group of operations 415. The group of operations 415 can include throwing an error for classified data via the HTTP host, and presenting a message to the user that classified data needs encryption.

As discussed above, in some implementations, the operation 412 includes sending a second request to the resource server. The resource server can authenticate the second request at in the operation 413, and then either granting or denying access to the server in the operation 414. The second request can include the call, the encrypted data payload, the authorization, and the encryption key. In some embodiments, the Application Programing Interface (API) of the service at the resource server can be accessed using the authorization. In some implementations, the encrypted data payload is delivered to the service, and the call is executed.

In some implementations, the group of operations 410 includes sending a decryption level. The decryption level can be based on a difference between the data sensitivity score and the data sensitivity threshold. For example, a higher decryption level results from the data sensitivity threshold greatly exceeding the data sensitivity score. In some implementations, this would represent a user role with greater permissions and access rights than necessary to access the type of sensitive data in the data payload (e.g., a particular resource classification). In some implementations, the higher decryption level allows the authentication server to decrypt more of the encrypted data payload, whereas a lower decryption level can protect the service from exposing potentially sensitive data by keeping sensitive portions of the data payload encrypted, or otherwise inaccessible to the service. In some implementations, executing the call involves decrypting the encrypted data payload based on the decryption level. For example, decrypting the encrypted data payload can result in a partially restored data payload, partially redacted data payload, completely restored data payload, or completely redacted data payload.

In some implementations, the method 400 includes sending a response. The response can be from the resource server to the client or to the client host. The response can be an API response generated from executing the call. In some implementations, the response is encrypted using the encryption key, and an encrypted response is sent to the client or to the client host.

FIG. 4B is another flow chart diagram that illustrates operations of an example resource classification layer in accordance with one or more embodiments of the present technology. As shown in FIG. 4B, a method 420 includes an operation 421 in which a request from is transmitted from a user via a client host to access or modify a resource at a resource server. The method 420 includes an operation 422 in which the client host forwards the request for an access token to an authorization server. In some implementations, the method 420 includes an operation 423 in which the authorization server authenticates and/or authorizes the request.

The method 420 includes an operation 424 in which the data payload is sent from the authorization server to an encryption service. The encryption service can include a data structure (e.g., a table, hash map, linked list, bit map, array, stack, or queue) that caches encryption keys. In some implementations, the encryption key is generated based on a method of encryption (e.g., symmetric encryption, asymmetric encryption, hash function, hybrid encryption, quantum encryption, or end-to-end encryption) and a strength of encryption (e.g., determined by key length, and entropy). The method and strength of encryption can be based on the data sensitivity score. In some implementations, the encryption key is assigned to the request. In some implementations, the encryption key is based on the data score. In some implementations, the encryption key is a key, and is assigned to the request based on the resource classification.

The method 420 includes an operation 425 in which the encryption service 407 determines an encryption key for the data payload based on an identifier (ID) value included with the data payload in the request. If the ID value is missing from the data payload (operation 426), a resource classification layer can determine an encryption key based on the data payload in operation 427). The resource classification layer can include one or more resource classification models to assign a classification to the data payload. In some implementations, the model comprises a rule engine (e.g., a rule-based expert system). Rule-based expert systems can include sets of “if-then” rules derived from a knowledge base, comprising resource classification rules and facts about resource classification types and the sorts of data payload features that are associated with them. These rules can be created by data security experts, data auditors, or other domain experts, and then encoded into the system. Such systems can include an inference engine that applies these rules from the knowledge base to the input data payloads to infer resource classifications. Such systems can also include a user interface, which data auditors and data security experts can use to answer questions regarding an accuracy of a predicted resource classification, and thereby refine the model's predictions.

The method 420 can includes an operation 428 in which the newly generated encryption key is returned to the encryption service, and an operation 429 in which the encryption service is updated to include a new key-value pair comprising the ID value (e.g., the key) paired with the newly generated encryption key from the resource classification layer (e.g., the value).

As illustrated in FIG. 4B, the method 420 can include an operation 430 in which the resource classification, data score, and/or encryption key are sent to an auditor. The auditor can verify the resource classification of the resource classification layer. Additionally, the auditor can amend the model comprised by the resource classification layer, or provide it with further tuning and/or training.

The method 420 can include an operation 431 performed by the authorization server to authorize the request, as well as transmitting the encryption key and data sensitivity score and resource classification from the resource classification layer to the authorization server.

The method 420 can include an operation 432 in which the data score and encryption key are returned to the HTTP client host from the authorization server. The data score and encryption key can be sent in an encryption transmission. The encryption transmission encryption transmission can include returning the encryption key along with an authorization (e.g., a Client Authorization Token) to the client host. In some implementations, the encryption transmission includes returning the key to the client host. The method 420 can include an operation 433 in which a second request is sent from the client directly to the resource server, with the authorization and the encrypted data payload. The resource server decrypts the encrypted data payload. Decryption can be performed by referring to a decryption key, or by submitting a request to the encryption service.

FIG. 4C is another flow chart diagram that illustrates operations of an example resource classification layer in accordance with one or more embodiments of the present technology. As shown in FIG. 4C, the method 440 includes an operation 441 in which a client sends a request for a resource at a resource server via a client host. The request can be a request for an access token, which can be sent to an authorization server (e.g., a gateway server) via the client host in operation 442.

In some implementations, the method 440 includes an operation 443 in which the data payload is sent from the authorization server to the resource classification layer. The resource classification layer can include one or more resource classification models to perform an operation 444 that involves assigning a classification to the data payloads, and determining a data sensitivity score for the data payload based on the classification.

As illustrated in FIG. 4C, an operation 445 includes transmitting the data sensitivity score from the resource classification layer to an encryption service. An encryption key can be retrieved from the encryption service in an operation 446 based on the data score or the resource classification from the resource classification layer. If such a data score or resource classification is not present in the encryption service, it may be added to the encryption service, along with a newly generated encryption key, in an operation 447.

The method 440 includes an operation 448 in which the data score and encryption key are transmitted back to the authorization server. In some implementations, the operation 448 includes authorizing and authenticating the request. The method 400 includes an operation 449 in which the encryption key and an authorization token are transmitted to the client host.

The method 400 includes an operation 450 in which the potentially sensitive data payload is encrypted using the specified encryption method and encryption strength. In some implementations, the potentially sensitive data payload of the call is then replaced with an encrypted data payload. In some implementations, the encrypted data payload can be partially encrypted, or totally encrypted, with a portion of the data fields comprised by the payload encrypted by the encryption method. These implementations can solve the problem of enforcing a security policy for individual features of sensitive data types that have become disassociated from the protected data type. For example, the Mobile Station International Subscriber Directory Number (MSISDN) is not related to CPNI on its own, but it can still allow those with access to trace sensitive data back to a subscriber of a telecommunications network.

The method 440 includes an operation 451 in which a request for a resource is transmitted from the client host to the resource server. The request can include an access token and an encrypted payload. The method 440 includes an operation 452 to authorize the request at the authorization server. The method 440 can include an operation 453, in which the authorization server either allows or denies access to the resource server.

In some implementations, an authentication server can authenticate the request and/or authorize a client after a resource server receives the request. The authentication server can validate incoming requests and check that a user token has been received. In some implementations, receiving a request at a resource server leads to the resource server transmitting a data score, authorization token, and/or authentication token to the authorization server.

The authorization server can authenticate the request and/or authorize a client that sent the request. The authorization server can retrieve a decryption key from a token cache (e.g., an encryption key cache service). The token cache can search for the decryption key based on an ID value. In some implementations, the token cache performs a recycle operation, in which decryption keys are changed according to a regular cadence (e.g., every thirty days).

### Artificial Intelligent System

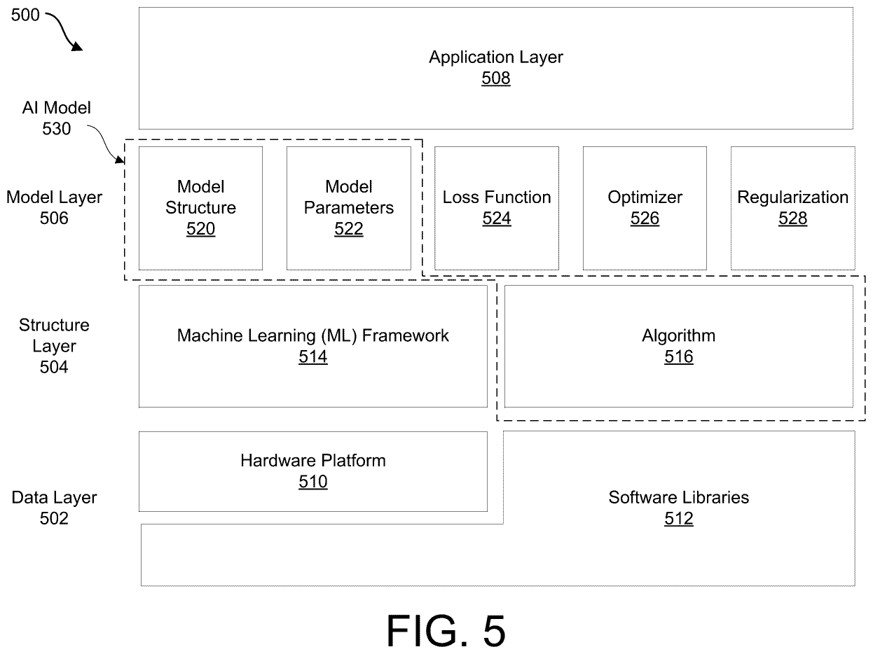

As shown in FIG. 5, the AI system 500 can include a set of layers, which conceptually organize elements within an example network topology for the AI system's architecture to implement a particular AI model 530. Generally, an AI model 530 is a computer-executable program implemented by the AI system 500 that analyses data to make predictions. Information can pass through each layer of the AI system 500 to generate outputs for the AI model 530. The layers can include a data layer 502, a structure layer 504, a model layer 506, and an application layer 508. The algorithm 516 of the structure layer 504 and the model structure 520 and model parameters 522 of the model layer 506 together form the example AI model 530. The optimizer 526, loss function engine 524, and regularization engine 528 work to refine and optimize the AI model 530, and the data layer 502 provides resources and support for application of the AI model 530 by the application layer 508.

The data layer 502 acts as the foundation of the AI system 500 by preparing data for the AI model 530. As shown, the data layer 502 can include two sub-layers: a hardware platform 510 and one or more software libraries 512. The hardware platform 510 can be designed to perform operations for the AI model 530 and include computing resources for storage, memory, logic and networking, such as the resources described in relation to FIGS. 4A, 4B, and 4C. The hardware platform 510 can process amounts of data using one or more servers. The servers can perform backend operations such as matrix calculations, parallel calculations, machine learning (ML) training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 510 can include Infrastructure as a Service (IaaS) resources, which are computing resources, (e.g., servers, memory, etc.) offered by a cloud services provider. The hardware platform 510 can also include computer memory for storing data about the AI model 530, application of the AI model 530, and training data for the AI model 530. The computer memory can be a form of random-access memory (RAM), such as dynamic RAM, static RAM, and non-volatile RAM.

The software libraries 512 can be thought of as suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource's instruction set architecture, allowing them to run quickly with a small memory footprint. Examples of software libraries 512 that can be included in the AI system 500 include Intel Math Kernel Library, Nvidia cuDNN, Eigen, and Open BLAS.

The structure layer 504 can include an ML framework 514 and an algorithm 516. The ML framework 514 can be thought of as an interface, library, or tool that allows users to build and deploy the AI model 530. The ML framework 514 can include an open-source library, an application programming interface (API), a gradient-boosting library, an ensemble method, and/or a deep learning toolkit that work with the layers of the AI system facilitate development of the AI model 530. For example, the ML framework 514 can distribute processes for application or training of the AI model 530 across multiple resources in the hardware platform 510. The ML framework 514 can also include a set of pre-built components that have the functionality to implement and train the AI model 530 and allow users to use pre-built functions and classes to construct and train the AI model 530. Thus, the ML framework 514 can be used to facilitate data engineering, development, hyperparameter tuning, testing, and training for the AI model 530. Examples of ML frameworks 514 that can be used in the AI system 500 include TensorFlow, PyTorch, Scikit-Learn, Keras, Cafffe, LightGBM, Random Forest, and Amazon Web Services.

The algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI model 530 through being trained while running computing resources of the hardware platform 510. This training allows the algorithm 516 to make predictions or decisions without being explicitly programmed to do so. Once trained, the algorithm 516 can run at the computing resources as part of the AI model 530 to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include examples of data payloads with accompanying labels, including audited resource classifications. The user may label the training data based on one or more classes and trains the AI model 530 by inputting the training data to the algorithm 516. The algorithm determines how to label the new data based on the labeled training data. The user can facilitate collection, labeling, and/or input via the ML framework 514. In some instances, the user may convert the training data to a set of feature vectors for input to the algorithm 516. Once trained, the user can test the algorithm 516 on new data to determine if the algorithm 516 is predicting accurate labels for the new data. For example, the user can use cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data (e.g., customer address, payment information, government ID) relate to the categories (e.g., CPNI, PCII, PPI, USGCI). Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format. The resource classification layer can use unsupervised learning to identify patterns in data payloads (e.g., to identify features that correspond with particular resource classifications) and so forth. In some implementations, performance of the encryption engine that can use unsupervised learning is improved because it can detect which features of a data payload are more sensitive than other features and need to be encrypted, as described herein.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 516 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 516 include factor analysis, item response theory, latent profile analysis, and latent class analysis.

The model layer 506 implements the AI model 530 using data from the data layer and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model 530 of the AI system 500. The model structure 520 defines the complexity of the pattern/relationship that the AI model 530 expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 520 may include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model's 530 performance during training. For instance, the loss function engine 524 can measure the difference between a predicted output of the AI model 530 and the actual output of the AI model 530 and is used to guide optimization of the AI model 530 during training to minimize the loss function. The loss function may be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model 530. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used may be determined based on the type of model structure 520 and the size of data and the computing resources available in the data layer 502.

The regularization engine 528 executes regularization operations. Regularization is a technique that prevents over-and under-fitting of the AI model 530. Overfitting occurs when the algorithm 516 is overly complex and too adapted to the training data, which can result in poor performance of the AI model 530. Underfitting occurs when the algorithm 516 is unable to recognize even basic patterns from the training data such that it cannot perform well on training data or on validation data. The regularization engine 528 can apply one or more regularization techniques to fit the algorithm 516 to the training data properly, which helps constraint the resulting AI model 530 and improves its ability for generalized application. Examples of regularization techniques include lasso (L1) regularization, ridge (L2) regularization, and elastic (L1 and L2 regularization).

The application layer 508 describes how the AI system 500 is used to solve problem or perform tasks. In an example implementation, the application layer 508 can include the resource classification layer from the methods illustrated by FIGS. 4A and 4B.

### Computer System

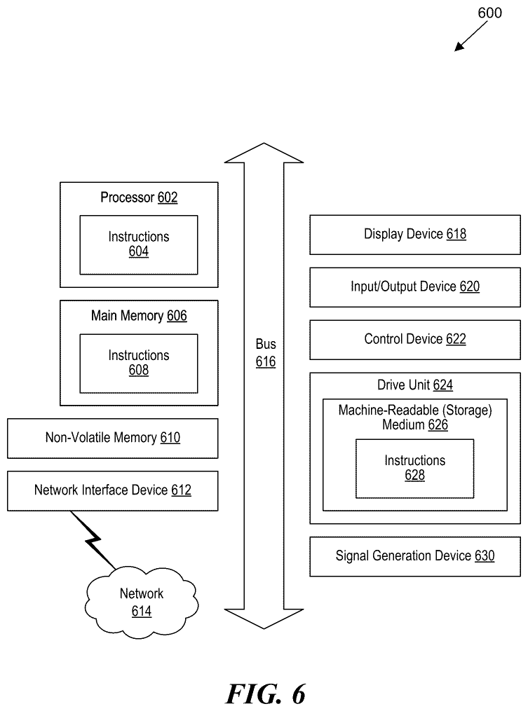

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to. ” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for. ” However, the use of the term “for” in any other context is not intended to invoke a similar interpretation. The applicant reserves the right to pursue such additional claim forms either in this application or in a continuing application.

I/We claim:

1. A method for secure communications, comprising:
receiving, by a resource classification layer, a request from a sender to obtain an access token to a receiver service in a telecommunications network,
wherein the sender is associated with a user role having permissions and access rights that correspond to a data sensitivity threshold,
wherein the request is associated a data payload;
assigning a classification value for the data payload using one or more resource classification models, wherein the one or more resource classification models are trained using past data payloads corresponding to known resource classification values;
generating a data sensitivity score based on a comparison of the classification value to a scale of classification values; and
verifying an authorization of the sender by determining whether the access token is grantable to the sender based on a comparison of the data sensitivity score against the data sensitivity threshold corresponding to the user role of the sender.

2. The method of claim 1, wherein the method further comprises:
assigning an encryption key to the request, wherein the encryption key is generated using an encryption method and an encryption strength for the data payload based on the data sensitivity score; and
returning the encryption key with the authorization to the sender.

3. The method of claim 1, wherein, upon the data sensitivity score falling below the data sensitivity threshold, the authorization includes the Access Token.

4. The method of claim 1, wherein, upon the data sensitivity score being equal to or greater than the data sensitivity threshold, the authorization includes a Classified Data Error.

5. The method of claim 1, wherein the scale of resource classifications comprises a hierarchy organized from least sensitive to most sensitive, the hierarchy including at least one of:
internal information,
restricted information,
protected critical infrastructure information (PCII),
customer proprietary network information (CPNI),
personally identifiable information (PII),
sensitive personally identifiable information (SPII), or
U.S. Government customer information (USGCI).

6. The method of claim 1, wherein the one or more resource classification models include a data mapping comprising pairs of data payloads and known resource classifications, and wherein assigning the classification value using the one or more resource classification models comprises:
identifying a matching data payload with a known resource classification from the data mapping; and
assigning the known resource classification to the data payload.

7. The method of claim 6, wherein the data payload comprises multiple matching data payloads, and wherein assigning the classification value comprises:
identifying multiple resource classifications from the multiple matching data payloads;
generating data sensitivity scores for the multiple resource classifications by comparing them to the scale of resource classifications;
comparing the data sensitivity scores to determine a resource classification with a greatest data sensitivity score; and
assigning the resource classification with the greatest data sensitivity score to the request.

8. A non-transitory, computer-readable storage medium comprising instructions recorded thereon, wherein the instructions when executed by at least one data processor of a system, cause the system to:
receive a request from a client at a resource classification layer to access a service,
wherein the request includes:
a data threshold, and
a call to the service, the call including a payload;
assign a resource classification to the call using a resource mapping with the payload as input, wherein the resource mapping is trained to output resource classifications based on payloads with known resource classifications as input;
generate a data score based on a comparison of the resource classification to a scale;
weigh the data score against the data threshold of the request to verify an authorization;
assign an encryption key to the request, wherein the encryption key includes a method of encryption and a strength of encryption for the payload based on the data score; and
return the encryption key with the authorization to the client.

9. The non-transitory, computer-readable storage medium of claim 8, wherein the authorization includes an Access Token or a Classified Data Error.

10. The non-transitory, computer-readable storage medium of claim 8, wherein assigning the encryption key to the request further comprises:
encrypting the payload using the method and the strength of encryption;
replacing the payload with an encrypted payload;
transmitting a second request directly to the service, including:
the call,
the encrypted payload,
the authorization, and
the encryption key;
accessing the service using the authorization;
delivering the encrypted payload to the service; and
executing the call.

11. The non-transitory, computer-readable storage medium of claim 10, wherein the authorization includes a decryption level based on a difference between the data score and the data threshold, and wherein executing the call comprises:
decrypting the encrypted payload based on the decryption level, such that possible results include:
a partially restored payload,
a partially redacted payload,
a completely restored payload, or
a completely redacted payload.

12. The non-transitory, computer-readable storage medium of claim 11, wherein executing the call further comprises:
generating a response;
encrypting the response using the encryption key; and
transmitting an encrypted response to the client.

13. The non-transitory, computer-readable storage medium of claim 8, wherein the resource mapping includes a data mapping comprising pairs of payloads and known resource classifications, and wherein assigning the resource classification using the resource mapping comprises:
identifying a matching payload with a known resource classification from the data mapping; and
assigning the known resource classification to the payload of the call.

14. The non-transitory, computer-readable storage medium of claim 13, wherein the payload has multiple matching payloads in the data mapping, and wherein assigning the resource classification comprises:
identifying multiple resource classifications from the multiple matching payloads;
generating data scores for the multiple resource classifications by comparing them to the scale of resource classifications;
comparing the data scores to determine a best resource classification with a greatest data score; and
assigning the resource classification with the greatest data score to the call.

15. A device for communication, comprising: at least one hardware processor, and at least one non-transitory memory storing instructions, which, when executed by the at least one hardware processor, cause the device to: transmit a request to a network to obtain an authorization to a service,
wherein the request includes a payload;
receive a key corresponding to the payload from the network as the authorization of the service,
wherein the key is generated based on a resource classification determined by a resource classification layer based on the payload,
wherein the resource classification layer is trained based on past payloads correspond to known classification values; and
transmit a second request to the network,
wherein the second request comprises an encrypted payload determined using the key.

16. The device of claim 15, wherein the request includes a data threshold, wherein the resource classification layer is configured to generate a data score based on a comparison of the resource classification to a scale, and wherein the authorization is determined by comparing a data score against the data threshold.

17. The device of claim 16, wherein, upon the data score being less than the data threshold, the authorization includes an Access Token.

18. The device of claim 16, wherein the authorization indicates a decryption level based on an amount that the data score exceeds the data threshold, such that a greater decryption level decrypts more of the encrypted payload.

19. The device of claim 18, wherein the encrypted payload is decrypted based on the decryption level, and wherein the decryption level determines that the encrypted payload is partially restored, partially redacted, completely restored, or completely redacted.

20. The device of claim 16, wherein the scale includes at least one of:
internal information,
restricted information,
protected critical infrastructure information (PCII),
customer proprietary network information (CPNI),
personally identifiable information (PII),
sensitive personally identifiable information (SPII), or
U.S. Government customer information (USGCI).
